(19) United States
(12) Patent Application Publication
(10) Pub. No.: US 2025/0095405 A1
(43) Pub. Date: Mar. 20, 2025

(54) SYSTEM FOR IDENTIFYING A DISPLAY DEVICE

(71) Applicant: TRINAMIX GMBH, Ludwigshafen Am Rhein (DE)

(72) Inventors: Patrick SCHINDLER, Ludwigshafen (DE); Peter FEJES, Ludwigshafen (DE)

(21) Appl. No.: 18/728,916

(22) PCT Filed: Feb. 15, 2023
(86) PCT No.: PCT/EP2023/053743

§ 371 Date: Jul. 15, 2024

(30) Foreign Application Priority Data
Feb. 15, 2022 (EP) 22156847.0

(51) Int. Cl. G06V 40/40; G06V 10/145; G06V 10/74; G06V 10/75; G06V 40/16

(52) U.S. Cl. CPC G06V 40/40; G06V 10/145; G06V 10/751; G06V 10/761; G06V 40/172

(57) ABSTRACT

Disclosed herein is a system for identifying a display device, where the system includes i) an image providing unit for providing an image of an object that has been acquired by projecting an illumination pattern through a display of the display device onto the object and imaging the illuminated object through the display. The system further includes ii) a reflection pattern extracting unit for extracting a reflection pattern corresponding to the illumination pattern from the image, and iii) an identity determining unit for determining an identity of the display device based on the reflection pattern.

### FIELD OF THE INVENTION

The invention relates to a system, a method and a computer program for identifying a display device, a system and a method for assessing an eligibility of a subject with respect to a display device, and a display device.

### BACKGROUND OF THE INVENTION

Identifying a user of a display device, such as a smartphone, may be necessary, for instance, for assessing whether the user is eligible for using the display device. Due to the convenience for the user associated with them and their relatively high reliability, face detection algorithms carried out on an image acquired by a front camera of the display device are often a preferred way for identifying the user. However, when the front camera is covered by the display, which can be preferred for other reasons, images acquired by the front camera may be disturbed, which can render face detection algorithms carried out on front camera images less reliable. An eligibility associated with the display device, such as an eligibility of a user to use a smartphone, may then no longer be reliably assessed. There is therefore a need for improved means for assessing an eligibility associated with a display device.

### SUMMARY OF THE INVENTION

It is an object of the invention to provide improved means for assessing an eligibility associated with a display device.

In a first aspect of the invention, a system for identifying a display device is provided, the system comprising a) an image providing unit for providing an image of an object, wherein the image has been acquired by projecting an illumination pattern through a display of the display device onto the object and imaging the illuminated object through the display, b) a reflection pattern extracting unit for extracting a reflection pattern corresponding to the illumination pattern from the image, and c) an identity determining unit for determining an identity of the display device based on the reflection pattern.

Since the reflection pattern is extracted from an image which has been acquired by projecting an illumination pattern through a display of the display device onto the object and imaging the illuminated object through the display, the reflection pattern carries information about optical characteristics of the display. Since the display is an essential part of any display device, this information can be used for identifying the display device, namely in terms of its display, based on the reflection pattern. Since the identity of the display device is determined, an eligibility associated with the display device can be assessed based on the determined identity. The system could therefore also be regarded as a system for assessing an eligibility associated with a display device.

The eligibility can refer, for instance, to an eligibility of the display device per se, or an eligibility of the display device in relation to a particular person. For example, the eligibility, i.e. the eligibility associated with the display device to be assessed, may refer to an eligibility of the display device for accessing, or allowing access to, a digital service, particularly depending on a user of the display device requesting the access. Hence, it may be assessed, for instance, a) whether the display device is eligible to allow users, i.e. anybody, to access the digital service at all, and/or b) whether a particular pair of display device and user is eligible to access the digital service.

An eligibility of the display device per se can be denied in case, for instance, the identity of the display device has been found to be manipulated by unauthorized third parties, or if the determined identity is only an alleged identity not corresponding to an actual identity of the display device, as may be the case when the provided image has actually been provided by unauthorized third parties. This can occur, for instance, if the image providing unit is manipulated by a third party, such as on a software basis, so as to not provide an image actually acquired by an image sensor of the display device to be identified, but instead a “fake” image, which has not been acquired using the display device to be identified. Such a “fake” image could, for instance, show a person eligible to use the display device, which may or may not be the person interacting with the device in the respective moment. The “fake” image may have been retrieved previously by the third party, which could be considered an attacker, from an image storage of the display device or from any other source. Cyberattacks of these kinds are also known as spoofing. In fact, the “fake” image is not necessarily acquired with a device different from the display device, but may also just be acquired using a back camera of the display device. If the “fake” image has not been acquired through the display of the display device, such as by using a back camera of the display device or any other imaging device, it will not comprise the characteristic optical disturbances associated with the display of the display device. It has been realized by the inventors that this lack of characteristic optical disturbances can be used for determining that a display device has been subject to an attack like spoofing, in which case it could be considered ineligible per se.

An eligibility of the display device in relation to a particular person can be denied in case, for instance, the person is known not to be authorized to use, or be granted access by, the display device, even though the same person may be authorized to use, or be granted access by, similar display devices. It has been found that the optical characteristics of display already mentioned above can also be used to distinguish between those display devices which a person is authorized to use, or be granted access by, and those display devices which a person is not authorized to use, or be granted access by. Hence, an authorization can be given or an access be granted in a device-specific manner. This can increase a general security level of authorization schemes irrespectively of how reliably users can be identified, since a device's identity can function as an authorization indicator just as important as a user's identity.

In other words, the above-mentioned object of the invention has been found to be achievable not only by an attempt to, for instance, correct for an optical disturbance caused by the display, but also by, conversely, using the optical characteristics of the display for generating an additional security element. What usually is considered as an obstacle for authorization schemes between display devices having cameras behind the display and their users, i.e. the possible optical disturbances caused by the display and rendering an authentication of users potentially less reliable, has been found by the inventors to actually be of use, namely for identifying display devices in terms of optical characteristics of their displays and employing the display device identities for extending the existing authorization schemes by a second authentication factor. The invention has been found to be of virtue particularly for deciding whether a user of a display device with a camera behind the display should be allowed to use, or be granted access by, the device, since this can depend on the identity of the person and additionally the identity of the device. In this case, the possibly decreased reliability of face detection algorithms, for instance, caused by the optical disturbances of the display, may be balanced by the additional reliability gained by identifying the display device. In view of the fact that optical disturbances are usually considered unwanted and therefore usually attempts to supress them are made, the path which the inventors have taken, namely making use of the optical disturbances by the display instead of trying to suppress or correct for them, thereby circumventing a problem existing in the field, is not only beneficial but also surprising.

The image providing unit is configured to provide the image of the object. It may also be configured to provide more than one image of the object, wherein then all of the provided images may have been acquired by projecting an illumination pattern through the display of the display device onto the object and imaging the illuminated object through the display. The image providing unit may receive the one or more images from an image sensor, such as of a front camera of a smartphone, for instance, and then provide the one or more images for further processing.

The illumination pattern can be understood as a distribution of illumination on the object. The distribution of illumination can appear differently depending on a viewing angle. For instance, in case the illumination pattern is projected using substantially undirected light with a relatively low intensity, such as light emitting diode (LED) light, light reflexes appearing on glossy surfaces of an object can change position depending on the viewing angle. On the other hand, if using a laser with a relatively high intensity as an illumination source, for instance, illumination patterns can be projected whose appearance, particularly whose position on non-glossy surfaces of the object, can be substantially independent of the viewing angle, at least in a direct view.

As will also be described further below with reference to the display device, projecting an illumination pattern through a display onto an object may refer to directing one or more illuminating light beams through the display onto the object such that the illumination pattern arises on the side of the display towards the object, particularly on the object. The illumination pattern may arise at least in part also from an interaction of the one or more illuminating light beams with the display. However, the one or more illumination light beams may also substantially form the illumination pattern already before passing through the display. The illumination pattern is preferably projected using an illumination source arranged in the display device. i.e. on the side of the display away from the object. The object, which is illuminated, can be part of a scene comprising the object, and may particularly also be a subject, such as a person or specifically a person's face. The term “scene” preferably refers to an arbitrary spatial region or environment. Imaging the illuminated object through the display can refer to capturing light reflected by the object and passing through display, wherein the light may be captured by an image sensor, such as an image sensor of a front camera included in a smartphone and covered by the display.

The reflection pattern extracting unit is configured to extract a reflection pattern corresponding to the illumination pattern from the image. Hence, the reflection pattern is extracted from the image, wherein the extracted reflection pattern corresponds to the illumination pattern projected onto the object. A reflection pattern may be considered as corresponding to the illumination pattern if the patterns share particular characteristics, or if, more generally, it can be determined that the reflection pattern corresponds to an imaged version of the illumination pattern, particularly a representation of the illumination pattern in terms of an image acquired through the display, wherein the terms “version” and “representation” may refer to a projection and/or transformation. Hence, the reflection pattern could also be understood as a distribution of illumination corresponding to the illumination pattern as viewed through the display. Since the display will comprise diffractive and/or scattering properties, the reflection pattern may comprise a diffraction and/or scattering pattern even though the illumination pattern, in a direct view onto the illuminated object, may comprise no or no substantial diffractive and/or scattering characteristics.

Extracting the reflection pattern may comprise identifying reflection features in the image. The reflection pattern extracting unit may, for this purpose, apply any of the following means, for instance: a filtering, a selection of at least one region of interest, a formation of a difference image between an image created by the sensor signals and at least one offset, an inversion of sensor signals by inverting an image created by the sensor signals, a formation of a difference image between an image created by the sensor signals at different times, a background correction, a decomposition into colour channels, a decomposition into hue, saturation, and brightness channels, a frequency decomposition, a singular value decomposition, applying a blob detector, applying a corner detector, applying a determinant-of-Hessian filter, applying a principle curvature-based region detector, applying a maximally stable extremal regions detector, applying a generalized Hough transformation, applying a ridge detector, applying an affine invariant feature detector, applying an affine-adapted interest point operator, applying a Harris affine region detector, applying a Hessian affine region detector, applying a scale-invariant feature transform, applying a scale-space extrema detector, applying a local feature detector, applying speeded up robust features algorithm, applying a gradient location and orientation histogram algorithm, applying a histogram of oriented gradients descriptor, applying a Deriche edge detector, applying a differential edge detector, applying a spatio-temporal interest point detector, applying a Moravec corner detector, applying a Canny edge detector, applying a Laplacian of Gaussian filter, applying a difference-of-Gaussian filter, applying a Sobel operator, applying a Laplace operator, applying a Scharr operator, applying a Prewitt operator, applying a Roberts operator, applying a Kirsch operator, applying a high-pass filter, applying a low-pass filter, applying a Fourier transformation, applying a Radon-transformation, applying a Hough transformation, applying a wavelet-transformation, a thresholding, creating a binary image.

In particular, the reflection pattern may be extracted from the image by considering the reflection pattern as a distribution of reflection features in the image, wherein the reflection features may be detected in the image based on their intensity profiles. The intensity profiles may be compared to predetermined reference intensity profiles, which may be predetermined based on characteristics of the used illumination source or the illumination pattern. A reflection feature is preferably understood as a part of the reflection pattern that can be spatially distinguished from other parts of the reflection pattern, wherein each reflection feature may have a certain spatial extent. Extracting the reflection pattern from an image may refer to cropping a patch from the image, wherein the patch comprises the distribution of reflection features. If the image is two-dimensional, the patch can have the shape of a square, a rectangle or a circle, for instance.

The identity determining unit is configured to determine the identity of the display device based on the reflection pattern, i.e. the reflection pattern that has been extracted from the image. The identity of the display device can refer, for instance, to a class of display devices having the same type of display, wherein the type of display may be characterized by its optical properties. A class of display devices may consist, for instance, of display devices sharing the same technology type, stemming from the same lot, having the same production year, et cetera. In general, however, it might also be possible to uniquely identify a display device, i.e., for instance, by establishing a one-to-one correspondence between reflection patterns and display devices. In some embodiments, the identity determining unit is configured to determine the identity of the display device based on the reflection pattern and the illumination pattern, which might be predetermined. The illumination pattern may be fixed, however, such that the determination of the identity of the display device might not actually depend on the illumination pattern.

In some embodiments, the illumination pattern comprises a laser spot and/or a light reflex, and the reflection pattern comprises a diffraction pattern corresponding to the laser spot and/or light reflex. The reflection pattern might in this case generally be a spot pattern. A light reflex can refer, for instance, to a spot of relatively high reflective intensity appearing on a glossy part of the object, such as a person's eye or glasses. If the object comprises glossy parts, a point-like illumination pattern can therefore be generated not only using a laser or other illumination sources generating a relatively narrow beam, but even with a relatively broad illumination beam, such as the beam of an LED. The illumination beam can then be so broad that the illumination could also be referred to as floodlight.

From a reflection pattern corresponding to a point-like illumination pattern, a diffraction kernel associated with the display can be derived. Images acquired through the display can be corrected by deconvoluting them using the diffraction kernel. Image-based eligibility assessments, such as face-recognition techniques using images of display-covered cameras, can therefore be improved using the diffraction kernel associated with the display.

In some embodiments, the illumination pattern comprises a plurality of light spots, particularly laser spots. Such an illumination pattern may be generated using, as illumination source, a vertical cavity surface emitting laser (VCSEL) or, as part of an illumination source, a diffractive optical element (DOE). In the latter case, the projected illumination pattern can arise from a diffraction of light generated by the illumination source at the DOE and subsequently at the display. Often, however, the diffraction caused by the DOE will be dominant in relation to the diffraction caused by the display, in which case the projected illumination pattern can be treated, to a sufficient approximation, to be caused by diffraction by the DOE only. It has been found that particularly OLED diffraction can favour a projector pattern, i.e. a diffraction pattern generated beforehand by a respective illumination source. An illumination pattern comprising a plurality of light spots allows for a particular accurate determination of the identity of the display device. In some embodiments, the identity of the display device is determined based on at least the 0^{th} and the 1^{st} order of the diffraction pattern. Preferably, the identity of the display device is determined based on all visible orders of the diffraction pattern, wherein “visible” is understood in relation to the sensitivity of an image sensor used for acquiring the image.

In some embodiments, the system further comprises a reference reflection pattern providing unit for providing a plurality of reference reflection patterns corresponding to respective reference display device identities, wherein the identity determining unit is configured to determine the identity of the display based further on the plurality of reference reflection patterns.

The reference reflection patterns may be provided based on a data base of acquired reference reflection patterns and associated reference display device identities. Since the reference display device identities could be regarded as defining display device classes, establishing the data base could also be viewed as a classification procedure, i.e. a classification of display devices in terms of correspondingly acquired reflection patterns.

It may be preferred that the reference reflection patterns are acquired analogously to how the reflection pattern is acquired based on which a display device is subsequently to be identified, i.e., for instance, using a same or similar configuration of image sensor and display and using a same or similar processing of the respective image data. However, it has been found that reference reflection patterns allowing for an accurate identification of display devices can also be acquired if this is not the case. In particular, it has been found that display devices can also be reliably identified using reference reflection patterns acquired based on illumination patterns projected onto other types of objects than those expected to be in front of the displays of display devices to be identified. This can be viewed as being due to the circumstance that the reflection patterns extractable from images of illuminated objects may be relatively independent of the type of object being illuminated. For instance, a reflection pattern extracted from an image of an illumination pattern projected onto a wall may be identical or similar to a reflection pattern extracted from an image of an illumination pattern projected onto a body part of a person. In particular, the variations across different reflection patterns caused by different optical display characteristics have been found to be usable as indicators for the respective display, and hence display device, irrespective of the projection targets, i.e. the illuminated objects.

In some embodiments, the system further comprises a similarity determining unit for determining a respective degree of similarity between the reflection pattern and each of the reference reflection patterns, wherein the identity determining unit is configured to determine the identity of the display device based on the determined degrees of similarity. For instance, the identity of the display device can be determined to be equal to the reference display device identity corresponding to the reference reflection pattern having the highest degree of similarity with the reflection pattern extracted by the reflection pattern extracting unit. The degrees of similarity could also be viewed as match values.

In some embodiments, the similarity determining unit comprises an artificial intelligence providing unit for providing an artificial intelligence, wherein the artificial intelligence has been trained to determine a respective degree of similarity between each of the plurality of reference reflection patterns and a reflection pattern provided as an input to the artificial intelligence, wherein the similarity determining unit is configured to determine the identity of the display device based on the degrees of similarity determined by the artificial intelligence upon being provided with the extracted reflection pattern. Again, for instance, the identity of the display device can be determined to be equal to the reference display device identity corresponding to the reference reflection pattern for which the artificial intelligence determines the highest degree of similarity with the reflection pattern extracted by the reflection pattern extracting unit. Either the respective degrees of similarity between the reference reflection patterns and the reflection pattern provided as an input for the artificial intelligence may correspond to the output of the artificial intelligence, or the final identity of the display device determined based thereon. The artificial intelligence can be trained, for instance, based on training data comprising the plurality of reference reflection patterns as training input data and the corresponding reference display device identities as training output data. The artificial intelligence can comprise an artificial neural network, for instance, particularly a convolutional neural network. However, it may also be preferred to use any other machine learning model, particularly any other classification model, as artificial intelligence. While convolutional neural networks are considered examples of classification models, other exemplary classification models that could be used include vision transformers or the like, for instance.

In some embodiments, the identity determining unit is configured to determine that the display device has no valid identity if the degree of similarity of the reflection pattern to each of the reference reflection patterns is below a predetermined threshold. No valid identity may be determined for the display device if, for instance, the display device has been manipulated. Such a manipulation can refer, for instance, to a software manipulation having the effect that the image providing unit provides an image of an object which is not actually present. Such an image might be referred to as a “fake” or “spoof” image.

In some embodiments, the identity determining unit is configured to determine that the display device has no valid identity if the degree of similarity of the reflection pattern to an expected one of the reference reflection patterns is below a predetermined threshold. The expected one of the reference reflection patterns can be understood as a reference reflection pattern of which it is assumed that it has truly been generated by the display device and which can therefore be used as an indicator for the true identity of the display device. If this assumption is made, i.e. if a particular reference reflection pattern can be expected, only one degree of similarity has to be determined by the similarity determining unit, namely between the reflection pattern extracted by the reflection pattern extracting unit and the expected reference reflection pattern. If this degree of similarity is below a predetermined threshold, a device manipulation may be assumed. As already indicated further above, the degree of similarity can, for instance, refer to a difference, such as an absolute mean difference or mean absolute difference value, between the two reflection patterns or the images showing them, wherein then this difference might need to be very small in order to exclude a device manipulation.

In a further aspect, a system for assessing an eligibility of a subject with respect to a display device is provided, the system comprising a) a subject identity determining unit for identifying the subject, b) a system for identifying the display device as described above, and c) an eligibility assessing unit for assessing an eligibility of the subject with respect to the display device based on a predetermined assignment of eligibilities to pairs of i) subject identities and ii) display device identities.

The subject identity determining unit can be configured to identify the subject based on an image of the subject, for instance, wherein the image can be compared to a reference image of the subject. Known face detection method can be used for this purpose, for instance.

In a further aspect, a display device is provided, the display device comprising a) a display, b) an illumination source for projecting an illumination pattern through the display onto an object, c) an image sensor for acquiring an image of the illuminated object through the display, and d) a system for identifying the display device as described above.

The term “display” as used herein preferably refers to a device configured for displaying one or more items of information, such as an image, a diagram, a histogram, a text and/or a sign, for instance. The display may refer to a monitor or a screen, and may have an arbitrary shape, such as a rectangular shape, for instance. Preferably, the display is an organic light emitting display (OLED) or a liquid crystal display (LCD). The term “display device” as used herein preferably refers to an electronic device comprising a display, such as a device selected from the following, for instance: a television device, a smartphone, a game console, a personal computer, a laptop, a tablet, a virtual reality device or a combination of the foregoing. As is also the case for OLEDs and LCDs, for instance, displays of electronic display devices typically comprise an electronic wiring structure used for controlling individual pixels of the display, and possibly also for touchscreen and/or further functionalities. Typically, the pixels are arranged in a periodic or quasi-periodic structure, such as in a lattice configuration, for instance. The wiring structure then inherits the periodicity or quasi-periodicity. Due to the typical dimensions of pixels, this has the effect that a display can diffract light passing through it. It is understood that a display is preferably substantially translucent or transparent, particularly for visible light and also light with higher wavelengths. This may specifically hold for pixel regions, while areas between pixels, where the wiring structure may be located, may be substantially opaque.

The illumination source is configured to project an illumination pattern through the display onto an object. The object may be arranged in or be part of a scene. The illumination source preferably refers to a device which is configured to generate light for illuminating a part of the environment of the display device. In particular, the illumination source can refer to a device which is configured to generate an illuminating light beam having a configurable direction. Projecting the illumination pattern through the display onto the object may refer to directing the illuminating light beam through the display onto the object, wherein the illuminating light beam interacts with the display such that an illumination pattern arises on the side of the display towards the object, particularly on the object. The illumination source may be configured to directly and/or indirectly illuminate the object, wherein the illumination pattern may arise in part from reflections and/or scattering at the display and/or surfaces in the environment of the object, wherein the reflected and/or scattered light may still be at least partially directed onto the object together with any light reaching the object directly from the illumination source. However, also no direct illumination is possible, in which case, for instance, the illumination source may be configured to illuminate the object, for instance, by directing an illuminating light beam towards a reflecting surface in the environment of the object such that the reflected light is directed onto the object.

The display device may comprise one or more illumination sources, wherein each of the illumination sources may be configured to project a respective illumination pattern through the display onto the object. The illumination sources may comprise an artificial illumination source, particularly a laser source and/or an incandescent lamp and/or a semiconductor light source, such as a light-emitting diode (LED), for instance, particularly an organic and/or inorganic LED. The light emitted by the one or more illumination sources may have a wavelength between 300 nm, particularly between 500 nm, and 1100 nm. Additionally or alternatively, the one or more illumination sources may be configured to emit light in the infrared spectral range, such as light having a wavelength between 780 nm and 3.0 μm. Specifically, light with a wavelength in the near infrared region where silicon photodiodes are applicable may be used, more specifically in the range between 700 nm and 1100 nm. Using light in the near infrared region has the advantage that the light is not or only weakly visible by human eyes and is still detectable by silicon sensors, particularly standard silicon sensors. Preferably, the display device comprises an infrared laser, particularly a near infrared laser, as a first illumination source for projecting a first illumination pattern through the display onto the object with light in the infrared, particularly near infrared, spectral region, and an LED as a second illumination source for projecting a second illumination pattern through the display onto the object with light having a wavelength in a different spectral region, particularly in a visible spectral region.

The term “projecting an illumination pattern” may generally be understood as referring to an emission of light by the respective illumination source such that an illumination pattern is generated in a spatial region, particularly on the object. More specifically, particularly depending on the illumination source, the term may refer to an emission of light from the illumination source, wherein the emitted light already propagates in a beam structure forming a certain pattern, which might be regarded as an emission pattern, wherein the propagating light may interact with the environment, such as the display, to eventually form the illumination pattern, particularly on the object, wherein the illumination pattern may be different from the emission pattern. For instance, if a laser is used as illumination source, an emission pattern may be generated using a diffractive optical element (DOE), or using a vertical-cavity surface-emitting laser (VCSEL) as laser. In a preferred embodiment, a VCSEL is used as an illumination source, wherein the VCSEL is used for generating an emission pattern, particularly a set of laser rays having predefined distances to each other, wherein then no diffractive optical element may be necessary.

A “ray” as referred to herein is understood as a light beam having a relatively narrow width, particularly a width below a predetermined value. A “beam” of light may comprise one or more light rays travelling in a respective direction, wherein the light beam may be considered travelling along a central direction being defined by an average of the directions along which the one or more light rays making up the light beam travel, and wherein a light beam may be associated with a corresponding spread or widening angle. A light beam may have a beam profile corresponding to a distribution of light intensity in the plane perpendicular to the propagation direction of the light beam, which may be given by the central direction. The beam profile may, for instance, be any of the following: Gaussian, non-Gaussian, trapezoid-shaped, triangle-shaped, conical. In particular, for instance, a trapezoid-shaped beam profile may have a plateau region and an edge region.

The one or more illumination sources may be configured to emit light at a single wavelength or at a plurality of wavelengths. A laser may be considered to emit light at a single wavelength, for instance, while an LED may be considered to emit light at a plurality of wavelengths. The plurality of wavelengths may particularly refer to a continuous, particularly extended, emission spectrum. The one or more illumination sources may be configured to generate one or more light beams for projecting the respective illumination pattern through the display onto the object. In particular, for instance, a VCSEL may also be considered as emitting a plurality of beams instead of a plurality of rays.

The one or more illumination sources may be arranged in the display device such that any light generated by the one or more illumination sources leaves the display device through the display of the display device. A propagation direction may be defined for any light, particularly any light beam, emitted by a respective illumination source as a main direction along which the emitted light propagates. The propagation direction may particularly be defined as a direction from the illumination source to the illuminated object. In propagation direction, the one or more illumination sources may be considered to be arranged in front of the display, while the illuminated object may be considered to be arranged behind the display. A viewing direction of a user using the display device may be opposite to the initial propagation direction of light emitted by the illumination source. The viewing direction of a user may rather correspond to a propagation direction of light being reflected by the object towards the image sensor, i.e. in a direction in which a reflection pattern may be formed from an illumination pattern.

In passing the display, any light generated by the one or more illumination sources may experience diffraction and/or scattering by the display, which may result in the illumination pattern. The display may function as a grating, wherein a wiring of the display, particularly of a screen of the display, may form gaps and/or slits and ridges of the grating. It is understood that the display is preferably translucent or transparent for the light generated by the one or more illumination sources, at least for a substantial part thereof.

The one or more illumination sources may be configured for emitting modulated or non-modulated light, wherein, if more than one illumination source is used, the different illumination sources may have different modulation frequencies which may be used for distinguishing light beams with respect to the illumination source having emitted them.

An optical axis may be defined as pointing in a direction perpendicular to the display, particularly a surface of the display, and towards the exterior of the display device. Any light generated by the one or more illumination sources may propagate parallel to the optical axis or tilted with respect to the optical axis, wherein being tilted refers to a non-zero angle between the propagation direction and the optical axis. The display device may comprise structural means to direct any light generated by the one or more illumination sources along the optical axis or in a direction not exceeding a predetermined angle with respect to the optical axis. For instance, for this purpose, the display device may comprise one or more reflective elements or prisms. Any light generated by the one or more illumination sources may then, for instance, propagate in a direction tilted with respect to the optical axis by an angle of less than ten degrees, preferably less than five degrees or even less than two degrees. Moreover, any light generated by the one or more illumination sources may exit the display device at a spatial offset to the optical axis, wherein the offset may, however, be considered arbitrary.

The illumination pattern projected on the object may comprise one or more illumination features, wherein each illumination feature illuminates a part of the object. An illumination feature is preferably understood herein as a spatial part of the illumination pattern that is distinguishable from other spatial parts of the illumination pattern and has a specific spatial extent. The illumination pattern may be, for instance, any of the following: a point pattern, a line pattern, a stripe pattern, a checkerboard pattern, a pattern comprising an arrangement of periodic and/or non-periodic features. The illumination pattern may comprise regular and/or constant and/or periodic sub-patterns, such as triangular, rectangular or hexagonal sub-patterns, or sub-patterns comprising further convex tilings, a pseudo-random point pattern or a quasi-random pattern, a Sobol pattern, a quasi-periodic pattern, a pattern comprising one or more known features, a regular pattern, a triangular pattern, a hexagonal pattern, a pattern comprising convex uniform tilings, a line pattern comprising one or more lines, wherein the lines may be parallel or crossing. The one or more illumination features may, for instance, be one of the following: a point, a line, a plurality of lines such as parallel or crossing lines, a combination of the foregoing, an arrangement of periodic and/or non-periodic features, or any other arbitrary-shaped feature. The one or more illumination sources may be configured to generate a cloud of points. They may comprise one or more projectors configured to generate a cloud of points such that the illumination pattern comprises a plurality of point patterns, wherein the illumination sources may comprise a mask in order to generate the illumination pattern from any light initially generated by the illumination sources.

It is understood that the illumination source and the image sensor are preferably arranged behind the display, i.e. for instance, between the display and any further internal electronics of the display device. The image sensor can particularly be a digital image sensor, such as a complementary metal-oxide semiconductor (CMOS) sensor, for instance. The display is preferably a translucent display. It can be, for instance, an OLED or a liquid crystal display (LCD). Preferably, the display comprises a periodic wiring structure, such as for the control of pixels or touchscreen functionalities.

The image providing unit is preferably configured to provide an image of an object in front of the display, wherein the image is acquired by the image sensor while the illumination source projects an illumination pattern through the display of the display device onto the object.

The image sensor is configured to acquire an image of the illuminated object through the display. In a preferred embodiment, the display device comprises a single camera comprising the image sensor. In other embodiments, the display device may comprise a plurality of cameras, wherein each of the cameras comprises a corresponding image sensor. A single camera may also comprise a plurality of image sensors.

Acquiring the image refers preferably to the process of capturing light reflected by the object towards the image sensor. Since the object is illuminated by an illumination pattern, acquiring the image particularly refers to capturing a reflection of the illumination pattern in the direction of the image sensor. The image sensor is preferably arranged in the display device such that any light captured by the image sensor passes the display of the display device. Hence, both the illumination source and the image sensor are preferably arranged behind the display of the display device in a viewing direction of a user of the display device. This allows for the use of a continuous, or uniform, display in the display device, which can decrease manufacturing complexity and allow for an increased display area, thereby increasing the amount of information that can be displayed. Any light reflected by the object and captured by the image sensor which passes the display will, even if the display is transparent or translucent for the light, interact with the display, particularly by diffraction and/or scattering caused by a wiring structure of the display. Hence, the illumination pattern on the object may appear changed in the image acquired by the image sensor. The illumination pattern as appearing in the image acquired by the image sensor may be referred to as reflection pattern. The reflection pattern may be a diffraction pattern arising from the illumination pattern. In particular, the reflection pattern may comprise one or more reflection features. A reflection feature is preferably understood as a part of the reflection pattern that can be spatially distinguished from other parts of the reflection pattern, wherein each reflection feature may have a certain spatial extent. The reflection pattern may be a superposition of diffraction patterns corresponding to illumination features. If the illumination pattern is point-like, the reflection pattern may comprise a plurality of point-like reflection features.

In particular, the image sensor can be an image sensor sensitive for light in spectral range emitted by the one or more illumination sources. For instance, the image sensor may comprise sensing means of a photovoltaic type, more preferably at least one semiconductor photodiode selected from the group consisting of: a Ge photodiode, an InGaAs photodiode, an extended InGaAs photodiode, an InAs photodiode, an InSb photodiode, a HgCdTe photodiode. Additionally or alternatively. Likewise, the image sensor may comprise sensing means of an extrinsic photovoltaic type, more preferably at least one semiconductor photodiode selected from the group consisting of: a Ge:Au photodiode, a Ge:Hg photodiode, a Ge:Cu photodiode, a Ge:Zn photodiode, a Si:Ga photodiode, a Si:As photodiode. Additionally or alternatively, the image sensor may comprise a photoconductive sensor such as a PbS or PbSe sensor, a bolometer, preferably a bolometer selected from the group consisting of a VO bolometer and an amorphous Si bolometer.

As already indicated further above, the illuminated object can be part of a scene comprising the object, and may particularly also be a subject, such as a person or specifically a person's face. However, a specific type of illuminated object is not necessary. The display device may be identified by the system described herein irrespective of the type of object being illuminated. No link between the illuminated object and the display device is required. For instance, it is not necessary that the illuminated object is a body part of a user of the display device. Meanwhile, the presence of some object being illuminated, i.e. of an object of any kind, may of course be considered necessary in order to be able to acquire an image, i.e. an image based on which the display device may be identified. In other words, the illumination pattern needs to be projected somewhere and reflected therefrom, and this “somewhere” could be considered an object-whether it be a wall, a person's face, his or her eye-glasses or any other part of a scene. Nevertheless, since the type of object being illuminated is not essential and/or since the presence of at least some object being illuminated may be regarded implicitly clear, the system presented herein could also be defined without reference to it.

Accordingly, a system for identifying a display device is presented that comprises a) an image providing unit for providing an image, wherein the image has been acquired by projecting an illumination pattern through a display of the display device and imaging the projected illumination pattern through the display, b) a reflection pattern extracting unit for extracting a reflection pattern corresponding to the illumination pattern from the image, and c) an identity determining unit for determining an identity of the display device based on the reflection pattern. A display device comprising the system may then comprise, apart from the system and a display, an illumination source for projecting an illumination pattern through the display, and an image sensor for acquiring an image of the projected illumination pattern through the display.

In a further aspect, a method for identifying a display device is provided, the method comprising a) providing an image of an object, wherein the image has been acquired by projecting an illumination pattern through a display of the display device onto the object and imaging the illuminated object through the display, b) extracting a reflection pattern corresponding to the illumination pattern from the image, and c) determining an identity of the display device based on the reflection pattern.

Also the above method may be defined without reference to the illuminated object. Hence, also a method for identifying a display device is provided which includes the steps of a) providing an image of an object, wherein the image has been acquired by projecting an illumination pattern through a display of the display device and imaging the projected illumination pattern through the display, b) extracting a reflection pattern corresponding to the illumination pattern from the image, and c) determining an identity of the display device based on the reflection pattern.

In a further aspect, a method for assessing an eligibility of a subject with respect to a display device is provided, the method comprising a) identifying the subject, b) identifying the display device as described above, and c) assessing an eligibility of the subject with respect to the display device based on a predetermined assignment of eligibilities to pairs of i) subject identities and ii) display device identities.

The systems and methods described above can be used, for instance, for any of the following purposes: a position measurement in traffic technology, an entertainment application, a security application, a surveillance application, a safety application, a human-machine interface application, a tracking application, a photography application, an imaging application or camera application, a mapping application for generating maps of at least one space, a homing or tracking beacon detector for vehicles, an outdoor application, a mobile application, a communication application, a machine vision application, a robotics application, a quality control application, a manufacturing application.

In a further aspect, a computer program for identifying a display device is provided, the program comprising program code means for causing a system for identifying a display device described above to execute the method for identifying a display device described above when the program is run on a computer controlling the system.

In a further aspect, a computer program for assessing an eligibility of a subject with respect to a display device is provided, the program comprising program code means for causing a system for assessing an eligibility of a subject with respect to a display device described above to execute a method assessing an eligibility of a subject with respect to a display device described above when the program is run on a computer controlling the system.

It shall be understood that the aspects described above, specifically the system of claim 1, the method of claim 11 and the computer program of claim 13, have similar and/or identical preferred embodiments, in particular as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically and exemplarily a system for identifying a display device,

FIG. 2 shows schematically an exemplarily parts of a display device and an object to be illuminated,

FIG. 3 shows schematically an exemplarily two wiring structures of a display of a display device,

FIG. 4a shows schematically and exemplarily a capturing of an image through a display,

FIG. 4b shows schematically and exemplarily the illumination pattern and the reflection pattern corresponding to the image capturing process shown in FIG. 4a,

FIG. 5 shows schematically and exemplarily an image of an object comprising a reflection pattern and a patch cropped from the image with a focus on the reflection pattern,

FIG. 6 shows schematically and exemplarily a method for identifying a display device, and

FIG. 7 shows schematically and exemplarily a method for assessing an eligibility associated with a display device.

### DETAILED DESCRIPTION OF EMBODIMENTS

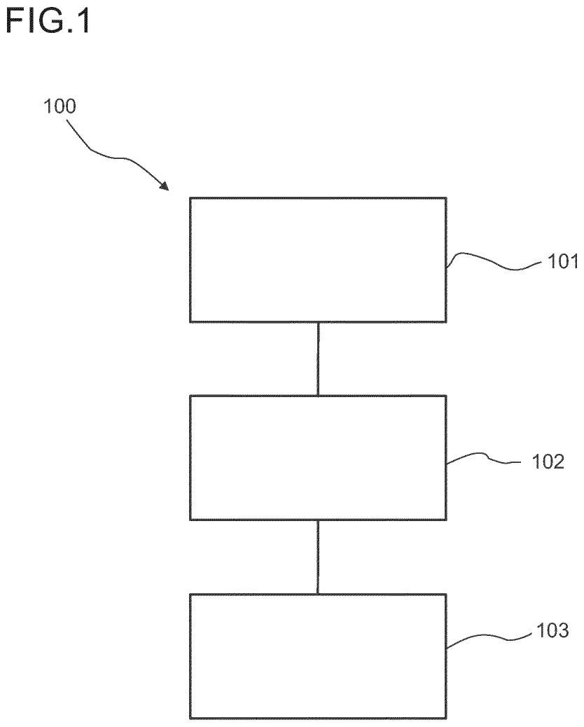

FIG. 1 shows schematically and exemplarily a system 100 for identifying a display device. The system 100 is configured for identifying the display device. It comprises an image providing unit 101 that is configured to provide an image 15 of an object 10, wherein the image 15 has been acquired by projecting an illumination pattern 20 through a display 201 of the display device onto the object 10 and imaging the illuminated object 10 through the display 201. The system 100 further comprises a reflection pattern extracting unit 102 that is configured to extract a reflection pattern 30, 30′ corresponding to the illumination pattern 20 from the image 15, and an identity determining unit 103 that is configured to determine an identity of the display device based on the reflection pattern 30, 30′.

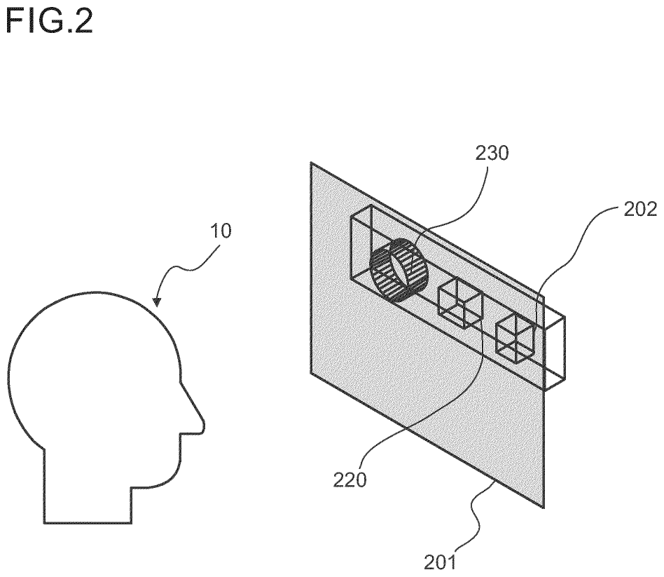

The system 100 is included in a display device, such as a smartphone, for instance, wherein the display device comprises the display 201, one or more illumination sources 202, 220 for projecting the illumination pattern 20 through the display 201 onto the object 10, and an image sensor 203 for acquiring the image 15 of the illuminated object 10 through the display. These further parts of the display device, as well as the object 10, are schematically and exemplarily shown in FIG. 2. In the illustrated embodiment, the object 10 is a face of a person, such as a user of the display device, and the image sensor 203 is included in a camera 230 of the display device. The one or more illumination sources comprise, in the illustrated embodiment, a laser projector 202 and an LED 220, wherein the camera 230, the laser projector 202 and the LED 220 may be integrated in a common optical module arranged behind the display 201 of the display device as viewed from the exterior of the display device, i.e. as viewed, for instance, from a perspective of the user of the display device.

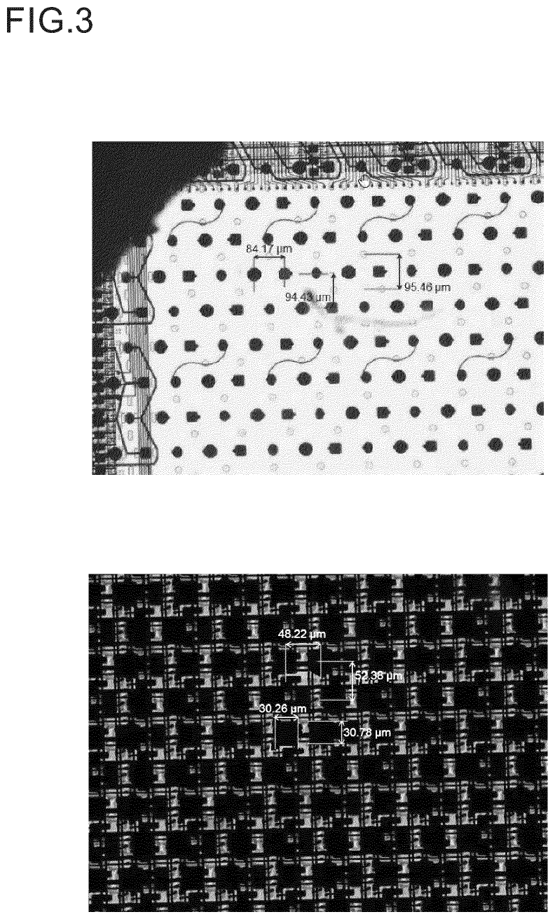

The display 201 has a microstructure as shown schematically and exemplarily in FIG. 3. FIG. 3 shows possible wiring structures for controlling the display. The wiring structures are periodic or quasi-periodic and hence serve as a diffraction grating for light having a wavelength not too different from a length scale characteristic for the periodicity or quasi-periodicity of the wiring structure. In the wiring structures shown in FIG. 3, lattice constants of between approximately 30 and 95 μm can be identified, wherein the lattice constants are different in different directions and for different sub-lattices. Sub-lattices may be defined with respect to different types of elements of a display wiring structure, possibly characterized by their electronic function and/or their shape, as may be particularly appreciated from left image shown in FIG. 3.

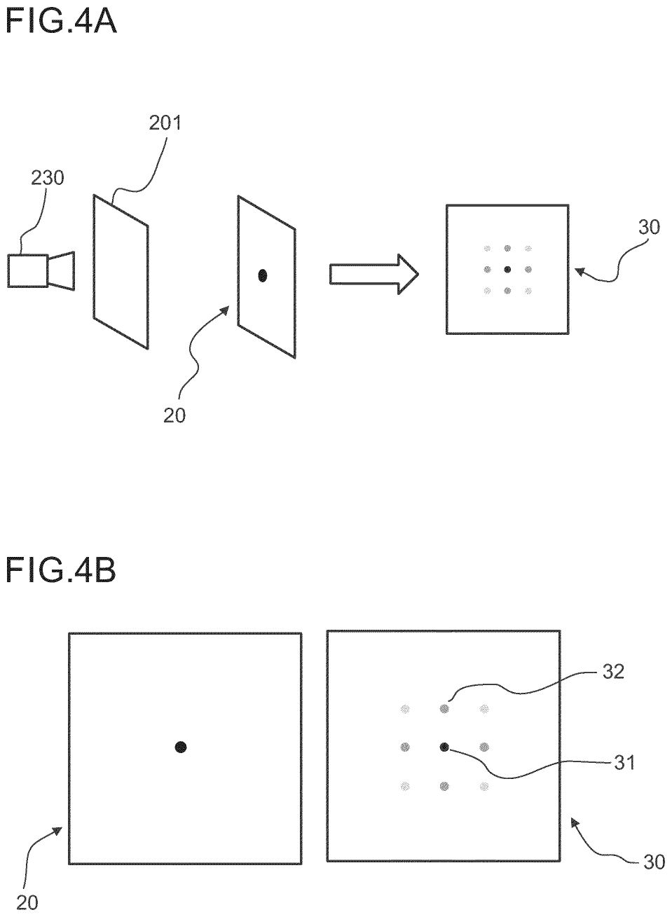

Due to the structure of the display 201, light emitted by the one or more illumination sources 202, 220 towards the exterior of the display device, which passes the display 201, may be disturbed, such as by diffraction and/or scattering, by the display 201. However, in some embodiments, this disturbance may be neglected due to the low distance between the one or more illumination sources and the display 201. Hence, for instance, the one or more illumination sources may be configured to project an illumination pattern, wherein the illumination pattern passes the display substantially undisturbed, such that the projection of the illumination pattern onto the object 10 substantially corresponds to the illumination pattern originally projected by the one or more illumination sources 202, 220. For instance, as seen in FIG. 4a, a laser may be used as illumination source, wherein the laser may be configured to project a relatively narrow beam towards the exterior of the target device. In FIG. 4a, the laser beam is projected not onto a specific object, but on a dark background, such that the illumination pattern 20 is clearly visible as a point-like structure, wherein the illumination pattern 20 may therefore also be considered as consisting of a single illumination feature corresponding to the spot seen in FIG. 4a. The laser light projected by the illumination source 230 illustrated in FIG. 4a is not substantially disturbed by the display 201, particularly not diffracted such that the single laser beam would be diffracted into several beams that would result in an illumination pattern comprising several spots as illumination features.

The illumination pattern 20, which is in this case a laser spot, is imaged through the display 201 using the camera 230 comprising the image sensor 203. The acquired image comprises, as seen in FIG. 4a, a reflection pattern corresponding to a diffraction pattern associated with the point-like illumination pattern 20. The reflection pattern 30, accordingly, comprises several reflection features of a point-like shape. As seen in FIG. 4b, which shows the illumination pattern and the reflection pattern of the illustrated embodiment side by side, it can be seen that the reflection pattern comprises a zeroth order 31 corresponding to the spot in the centre of the reflection pattern and higher orders 32 corresponding to spots surrounding the spot in the centre of the reflection pattern 30, wherein the spots of higher order have a lower intensity as compared to the spot of the zeroth order 31. The distances between the spots corresponding to the higher orders of the reflection pattern to the spot corresponding to the zeroth order are determined by the periodicity of the microstructure of the display 201 in the respective directions. Also the intensities of the spots in the reflection pattern are determined by optical characteristics of the display device 201, particularly its microstructure. Hence, the reflection pattern 30 can be used for identifying the display 201 and thereby also the display device, which comprises the display 201.

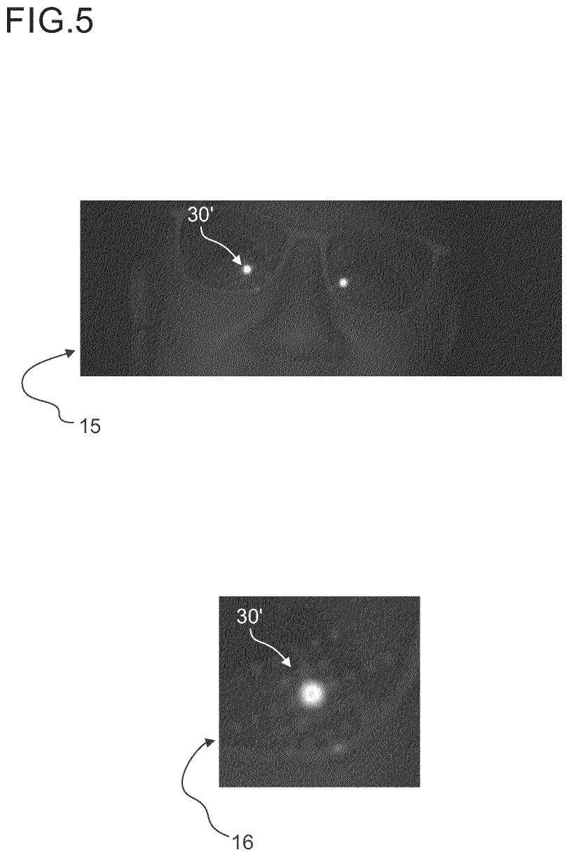

FIG. 5 shows schematically and exemplarily a different image 15 acquired by the image sensor 203, wherein in this case an illumination pattern 20 has been projected onto an actual object, the object being, in this case, sunglasses worn by a person looking at the display 201 of the display device. The reflection pattern 30′ is again a spot pattern, wherein in this case two similar spot patterns appear in the image 15, one on each of the eyepieces of the sunglasses. FIG. 5 also shows a patch 16 cropped from the image 15, wherein the patch 16 focuses on the part of the reflection pattern appearing on the right eyepiece of the sunglasses. The reflection pattern 30′ has been generated using LED floodlight for illumination.

As illustrated in FIGS. 4 and 5 in an exemplary and schematic manner, in some embodiments, the illumination pattern 20 comprises a laser spot and/or a light reflex, and the reflection pattern comprises a diffraction pattern corresponding to the laser spot and/or the light reflex. The correspondence between the diffraction pattern and the laser spot and/or light reflex may refer to the optical relation given by the fact that the diffraction pattern arises when the reflected light of the laser spot and/or light reflex passes the display 201.

The reflection pattern may be extracted from the image 15 by considering it as a distribution of reflection features in the image 15, wherein the reflection features may be detected in the image 15 based on their intensity profiles. For instance, the reflection pattern extracting unit 102 may be provided with information about an expected intensity profile for reflection features in the reflection pattern 30, 30′, wherein this information may be acquired from calibration measurements. In an example, the illumination source may be configured to project a spot pattern as illumination pattern into the exterior of the display device, wherein the spots of the spot pattern, which may be regarded as illumination features, can be considered as having a radially symmetric intensity profile with a substantially sharp edge towards the exterior, wherein this or a similar intensity profile may also be assumed for the reflection features. Then, areas in the image 15 having such an expected intensity profile may be considered as reflection features, wherein the collection of reflection features may be considered as forming the reflection pattern. In an embodiment, a bounding box may be delineated in the image 15 such that the bounding box surrounds all detected reflection features in the image, wherein extracting the reflection pattern may refer to cropping a patch from the image 15 corresponding to the bounding box.

Details regarding the detection of reflection features in the image 15 are disclosed in WO 2021/105265 A1, which is herein incorporated by reference in its entirety.

The identity determining unit 103 is configured to determine an identity of the display device based on the reflection pattern 30, 30′ extracted from the image 15. In a preferred embodiment, the identity of the display device is determined based on at least the zeroth and the first order of the diffraction pattern. Hence, not only the zeroth order of the diffraction pattern is used for determining the identity of the display device, but also higher orders. For instance, all orders up to a predetermined intensity threshold may be used. Using also orders different from the zeroth order allows for an improved identification of the display device in terms of its display 201, since the higher diffractive orders encode particularly useful optical properties of the microstructure in the display.

In some embodiments, the system 100 further comprises a reference reflection pattern providing unit for providing a plurality of reference reflection patterns 30, 30′ corresponding to respective reference display device identities, wherein the identity determining unit 103 is configured to determine the identity of the display 201 based further on the plurality of reference reflection patterns 30, 30′.

In some embodiments, the system 100 further comprises a similarity determining unit for determining a respective degree of similarity between the reflection pattern 30, 30′, which is extracted from the image 15, and each of the reference reflection patterns, wherein the identity determining unit is configured to determine the identity of the display device based on the determined degrees of similarity.

In particular, the similarity determining unit can comprise an artificial intelligence providing unit for providing an artificial intelligence, wherein the artificial intelligence has been trained to determine a respective degree of similarity between each of the plurality of reference reflection patterns and a reflection pattern provided as an input to the artificial intelligence, wherein the similarity determining unit may be configured to determine the identity of the display device based on the degrees of similarity determined by the artificial intelligence upon being provided with the extracted reflection pattern 30, 30′.

In some embodiments, the identity determining unit 103 is configured to determine that the display device has no valid identity if the degree of similarity of the reflection pattern to each of the reference reflection patterns is below a predetermined threshold. This is particularly preferred if the number of reference reflection patterns can be assumed to be sufficiently complete and accurate, since it can then be inferred from a degree of similarity of the reflection pattern 30, 30′ to each of the reference reflection patterns that is below the predetermined threshold that the reflection pattern has not been caused by a known display of a display device, such that it may then be assumed that the image 15 only comprises a fake or spoof version of a reflection pattern. The identity determining unit 103 may also be configured to determine that the display device has no valid identity if the reflection pattern extracting unit 102 was not able to extract any reflection pattern from the image 15.

A system for assessing an eligibility of a subject with respect to a display device may comprise a subject identity determining unit for identifying the subject, the system 100 for identifying the display device, and an eligibility assessing unit for assessing an eligibility of the subject with respect to the display device based on a predetermined assignment of eligibilities to pairs of a) subject identities and b) display device identities.

The subject identity determining unit may be configured to identify the subject in a known manner. For instance, geometry-based and/or template-based face recognition methods may be applied. Geometry-based methods may analyse local facial features and their geometric relationship, while template-based methods can employ statistical tools like support vector machines, principal component analyses, linear discriminant analyses, kernel or trace methods. Also approaches based on Gabor wavelets and/or artificial neural networks can be used, for instance.

The eligibility assessing unit is configured to assess the eligibility of the subject with respect to the display device based on the determined assignment of eligibilities to pairs of a) subject identities and b) display device identities. The predetermined assignment may indicate, for instance, for a given subject whose identity is determinable by the subject identity determining unit for which display devices, which are referred to by their identity in terms of a type of display comprised by the display device, for instance, the subject is eligible. In a very concrete example, a user of a cloud service accessible via a plurality of mobile display devices may only be eligible to access the cloud service via his or her personal mobile display device, wherein this may be indicated in terms of a predetermined assignment of eligibility only to the pair of this particular user and his personal mobile display device, while other pairs, consisting of this particular user and other mobile display devices, may be assigned, in terms of the predetermined assignment of eligibilities, a missing, i.e. no, eligibility.

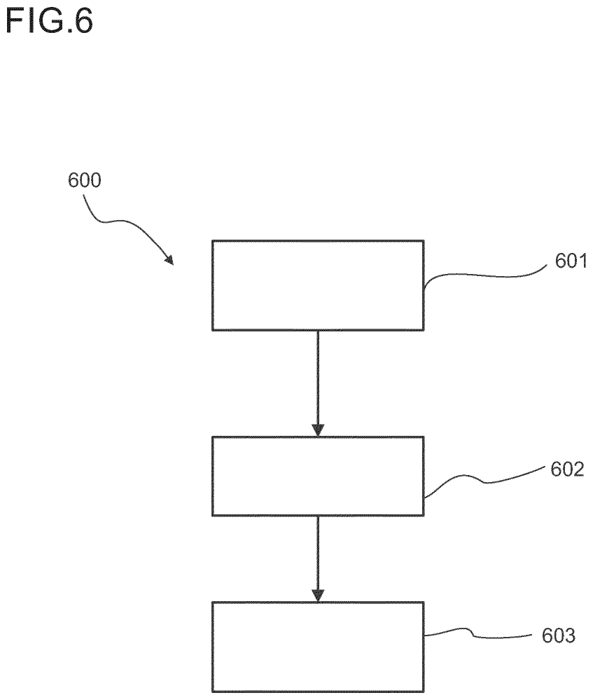

FIG. 6 shows schematically and exemplarily a method 600 for identifying a display device, wherein the method comprises a step 601 of providing an image 15 of an object 10, wherein the image 10 has been acquired by projecting an illumination pattern 20 through a display 201 of the display device onto the object 10 and imaging the illuminated object 10 through the display 201, a step 602 of extracting a reflection pattern 30, 30′ corresponding to the illumination pattern 20 from the image 15, and a step 603 of determining an identity of the display device based on the reflection pattern 30, 30′.

A method for assessing an eligibility of a subject with respect to a display device can comprise the steps of a) identifying the subject, b) identifying the display device according to the method 600, and c) assessing an eligibility of the subject with respect to the display device based on a predetermined assignment of eligibilities to pairs of i) subject identities and ii) display device identities.

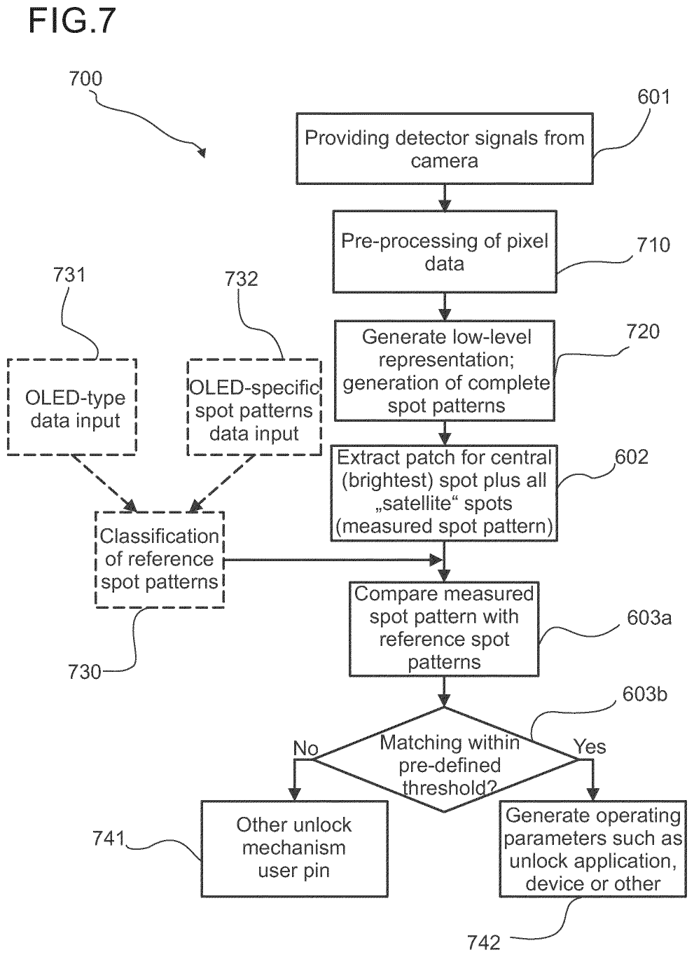

FIG. 7 shows schematically and exemplarily a particular embodiment of the method 600 for identifying a display device. In this particular method 700, the image 15 is provided in a step 601, wherein providing the image particularly refers to providing signals received from the image sensor 203 of the camera 230. The provided signals comprise pixel data, since the image 15 is a digital image composed of pixels. In a step 710, the pixel data are preprocessed. The preprocessing can involve, for instance, identifying the brightest reflection features in the image, wherein already an evaluation of the brightest reflection features may be carried out. This evaluation can correspond to the evaluation subsequently carried out for more reflection features. As already indicated further above, reflection features, which may be considered spot-like, can be identified using, for instance, blob detection algorithms and/or using Laplacian or Gaussian filters.

In a following step 720, a low-level representation of the reflection pattern 30, 30′ comprised by the pixel data is generated, wherein, in particular, all diffractive orders of the reflection pattern 30, 30′ can be considered for the low-level representation.

In a following step 602, an image patch is extracted from the complete image formed by the pixel data, such as by cropping with a predefined margin, for instance, wherein the patch includes at least the brightest reflection features of the reflection pattern and the nearest neighbours from the reflection features in the reflection pattern. The nearest neighbours may also be referred to as satellite reflection features corresponding to a central reflection feature. If the reflection pattern is a spot pattern, the extracted image patch may include a central, brightest spot and at least all satellite spots of the central spot. Satellite spots may be understood as all spots surrounding a central spot in a symmetric or quasisymmetric manner and/or correspond to a predetermined diffractive order, wherein the predetermined diffractive order may particularly be 1 or 2. The extracted image patch is then compared, in a step 603a, with reference image patches comprising reference reflection patterns in order to determine respective degrees of similarity. The reference image patches comprising the reference spot patterns each have a specific device identity associated, wherein this association between reference image patches comprising reference reflection patterns and corresponding device identities has been established in the course of a classification procedure 730. The classification procedure 730 comprises collecting reference reflection patterns for display devices having a plurality of identities, wherein the identities are encoded in terms of the displays integrated in the plurality of display devices, particularly their optical properties, which may depend on the production lot they stem from, their production year, et cetera. Establishing the plurality of reference display device identities, which might also be regarded as display device classes, may be regarded as a subprocess 731, as indicated in FIG. 7. Likewise, collecting the plurality of reflection patterns for each of the plurality of display device identities might be regarded as a subprocess 732, as indicated in FIG. 7. Based on the determined degrees of similarity between the extracted image patch from step 602 and the plurality of reference image patches arising from the classification established in the process 730 having the subprocesses 731, 732, which is determined in step 603a, an identity of the display device is determined in step 603b, wherein if the determined degree of similarity is above a predefined matching threshold for any of the reference display device identities to which an eligibility has been assigned, the display device may be determined to be eligible, such that operating parameters may be generated allowing to unlock an application on the display device, for instance, in a step 742. If, on the other hand, the determined degree of similarity is not above the matching threshold for any of the reference display device identities to which an eligibility has been assigned, further security measures may be taken in a step 741. For instance, if an eligibility of the display device with respect to a user is assessed, an unlock mechanism may be triggered in step 741 which prompts the user to enter a user pin.

The process shown in FIG. 7 can be considered an authentication procedure that is only based on one or more central spots, including the corresponding satellite spots, but which can be combined, for instance, with known face recognition procedure as described, for instance, in WO 2021/105265 A1, in order to provide a further feature to be evaluated by the authentication procedure and/or an according two-factor authentication of face and display.

Embodiments disclosed herein relate to the use of device-specific signature for generating an additional security feature, particular for display device comprising, for instance, OLEDs as displays. As outlined in detail, a device-specific signature can correspond to reflections from flood illumination on glossy targets like eyes and/or glasses or to laser points projected on a specific target, all of which cause device-specific diffraction patterns when imaged through a display of the device.

There exist approaches for identifying a user of a display device, such as a smartphone, in terms of his or her face by using laser equipment arranged inside the display device, i.e. behind a display of the display device. However, further improved means for assessing an eligibility associated with a display device are desirable.

In addition, WO 2021/105265 A1 discloses a “DPR” technology for depth measurements which has the advantage that it is robust against disturbances. Hence, if the projector and the camera is put behind an OLED display, the reflection image is disturbed by scattering, but the DPR technology is robust enough that it can still measure distance and material of a detected object or person. In this technique, the zero-order scattering spot, so the most intense spot, can be analyzed and the higher order scattered spots can be discarded. In particular, the technique disclosed in WO 2021/105265 A1 relies only on a single camera.

It has been found that, in order to improve the reliability and safety of an identification procedure based on such known approaches, it may be included in the identification procedure whether face recognition is performed on a correct device (such as a smartphone, for instance), i.e. whether the current user is a correct user, i.e. he/she is entitled to get access to the underlying device at all, and whether the underlying device is potentially manipulated in order to get unauthorized access.

A corresponding display device may include translucent display (such as an LCD, an OLED, etc.) comprising a periodic wiring structure (for control of pixels, touchscreen, etc.). Behind the display, there may be arranged at least one laser light emitter (e.g., LED illuminator including several laser LEDs, one or more VCSELs, refractive optics, etc.) and a light receiver, like an image sensor, which generates picture pixels (e.g., in a digital 1D or 2D camera), based on the received light being reflected by a person's face or an (other) object.

The emitted laser light (e.g., at least one spot, a spot pattern or a floodlight-“Flächenstrahler” in German) may strike a person's face or other body part, like a hand or a finger, or an object or scene in front of the display, wherein the reflected light may be received by the light receiver, thus generating at least one picture.

The at least one received picture (preferably a 2D image), in particular the reflected light spot or spot pattern (preferably pictures of the reflected laser image together with a floodlight, e.g. LED light, picture, because using both picture types can provide for more features, thus increasing reliability/security of object/person/scene identification), is evaluated by means of image processing. Hereby, the at least one laser and/or floodlight-based received picture of the scene/object/person is digitalized, wherein from the digitalized picture at least one patch (square-, rectangle- or circle-shaped) may be extracted which includes a central (brightest) spot and all other by diffraction/grating caused (satellite) spots.

In contrast to the prior art (where the mentioned satellite spots are preferably completely disregarded for the identification process), such a received complete spot pattern of a (or around a) central/bright spot, which is preferably not caused by and is independent of the measured scene/object, in the extracted patch (in particular including all satellites) can be further processed by a) comparing the received spot pattern with existing (expected) and/or pre-classified reference spot patterns, e.g. by means of pixel-by-pixel evaluation, pattern recognition using artificial neural networks or other machine learning or (standard) image processing methods, and b) determining a match value (or score), between the received spot pattern and the reference spot patterns, e.g. based on a corresponding predefined threshold.

It may be noted that the detection mechanism used herein, particularly for identification, can be assumed to be physically based on possible variations of satellite spots regarding their position (spatial arrangement/distribution) and brightness, being caused by display-specific diffraction and corresponding variations.

The measures disclosed herein do not rely, for instance, on depth measurements as disclosed, for instance, in WO 2021/105265 A1. But they are compatible with such depth measurements.

In some applications, based on the determined match value, a device-specific identification of the scene/object/person can be performed that may allow for unlocking such devices, touch screens and/or applications. Additionally or alternatively, based on the determined match value, a possible manipulation of the display device (or manipulated software in display device or even a different display device) can be detected. Moreover, for instance, the mentioned pre-classification of reference spot patterns, for an exemplary OLED display, can be accomplished, for instance, through classifying OLED-specific spot patterns/profiles with respect to existing OLED types (OLED technology type, lot, production year, etc.), using, e.g., an artificial neural network that is trained based on according training data. Generally, more reliable and secure identification/authentication of persons (faces) and objects, particularly based on a herein-concerned display device in combination with a corresponding user (e.g. the owner of the display device) can be achieved, while also preventing or being able to detect an underlying device manipulation.

A display device as referred to herein may comprise at least one translucent display configured for displaying information, wherein the device may comprise a) at least one illumination source being arranged behind the translucent display and configured for projecting at least one illumination pattern comprising a plurality of illumination features, through the translucent display, on at least one scene; b) at least one optical sensor being arranged behind the translucent display and having at least one light sensitive area, wherein the optical sensor is configured for determining at least one first image comprising a spot pattern generated by the scene in response to illumination by the illumination features, and c) at least one evaluation device, wherein the evaluation device is configured for evaluating the first image, wherein the evaluation of the first image comprises identifying the reflection features of the first image based on at least one beam profile, and wherein the evaluation of the first image comprises comparing reflected spot patterns of the at least one beam profile with reference spot patterns and for determining a match value between a reflected spot pattern and the reference spot patterns. The evaluation device itself may be considered as being a system for identifying a display device, as described in detail further above.

A corresponding method may be suitable for measuring through a translucent display of at least one display device as further outlined above, wherein the method may the steps carried out by the at least one illumination source, the at least optical sensor and the at least one evaluation device as mentioned before

The display device and the method may be used for a purpose of use selected from the group consisting of: a position measurement in traffic technology; an entertainment application; a security application; a surveillance application; a safety application; a human-machine interface application; a tracking application; a photography application; an imaging application or camera application; a mapping application for generating maps of at least one space; a homing or tracking beacon detector for vehicles; an outdoor application; a mobile application; a communication application; a machine vision application; a robotics application; a quality control application; a manufacturing application.

Although in many of the above-described embodiments an eligibility of a person with respect to a display device is assessed based on an identification of the display device, also an eligibility of (other) objects and/or a scene with respect to the display device may be assessed based on an identification of the display device by using the same or similar means. Assessing an eligibility of a person, an (other) object and/or a scene may also comprise an identification of the person, the (other) object and/or the scene, such that the measure described herein may also be regarded as allowing for a device-specific identification of a person, an (other) object and/or a scene.

Other variations to the disclosed embodiments can be understood and effected by those skilled in the art in practicing the claimed invention, from a study of the drawings, the disclosure, and the appended claims.

The term “image” as used herein is not limited to an actual visual representation of the imaged object. Instead, an “image” as referred to herein can be generally understood as a representation of the imaged object in terms of data acquired by imaging the object, wherein “imaging” can refer to any process involving an interaction of electromagnetic waves, particularly light or radiation, with the object, specifically by reflection, for instance, and a subsequent capturing of the electromagnetic waves using an optical sensor, which might then also be regarded as an image sensor. In particular, the term “image” as used herein can refer to image data based on which an actual visual representation of the imaged object can be constructed. For instance, the image data can correspond to an assignment of color or grayscale values to image positions, wherein each image position can correspond to a position in or on the imaged object. The images or image data referred to herein can be two-dimensional, three-dimensional or four-dimensional, for instance, wherein a four-dimensional image is understood as a three-dimensional image evolving over time and, likewise, a two-dimensional image evolving over time might be regarded as a three-dimensional image. An image can be considered a digital image if the image data are digital image data, wherein then the image positions may correspond to pixels or voxels of the image and/or image sensor.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage. Procedures like the providing of an image, the extracting of a reflection pattern, the determining of an identity of the display device, et cetera, performed by one or several units or devices can be performed by any other number of units or devices. These procedures can be implemented as program code means of a computer program and/or as dedicated hardware. A computer program product may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

1. A system for identifying a display device, the system comprising:
an image providing unit for providing an image of an object, wherein the image has been acquired by projecting an illumination pattern through a display of the display device onto the object and imaging the illuminated object through the display,
a reflection pattern extracting unit for extracting a reflection pattern corresponding to the illumination pattern from the image, and
an identity determining unit for determining an identity of the display device based on the reflection pattern.

2. The system according to claim 1, wherein the illumination pattern comprises a laser spot and/or a light reflex, and the reflection pattern comprises a diffraction pattern corresponding to the laser spot and/or light reflex.

3. The system according to claim 1, wherein the reflection pattern is extracted from the image by considering it as a distribution of reflection features in the image, wherein the reflection features are detected in the image based on their intensity profiles.

4. The system according to claim 1, wherein the identity of the display device is determined based on at least the 0^{th} and the 1^{st} order of the diffraction pattern.

5. The system according to claim 1, wherein the system further comprises a reference reflection pattern providing unit for providing a plurality of reference reflection patterns corresponding to respective reference display device identities, wherein the identity determining unit is configured to determine the identity of the display based further on the plurality of reference reflection patterns.

6. The system according to claim 5, wherein the system further comprises:
a similarity determining unit for determining a respective degree of similarity between the reflection pattern and each of the reference reflection patterns,
wherein the identity determining unit is configured to determine the identity of the display device based on the determined degrees of similarity.

7. The system according to claim 6, wherein the similarity determining unit comprises:
an artificial intelligence providing unit for providing an artificial intelligence, wherein the artificial intelligence has been trained to determine a respective degree of similarity between each of the plurality of reference reflection patterns and a reflection pattern provided as an input to the artificial intelligence,
wherein the similarity determining unit is configured to determine the identity of the display device based on the degrees of similarity determined by the artificial intelligence upon being provided with the extracted reflection pattern.

8. The system according to claim 4, wherein the identity determining unit is configured to determine that the display device has no valid identity if the degree of similarity of the reflection pattern to each of the reference reflection patterns is below a predetermined threshold.

9. A system for assessing an eligibility of a subject with respect a display device, the system comprising:
a subject identity determining unit for identifying the subject,
the system for identifying the display device according to claim 1, and
an eligibility assessing unit for assessing an eligibility of the subject with respect to the display device based on a predetermined assignment of eligibilities to pairs of a) subject identities and b) display device identities.

10. A display device comprising:
a display,
an illumination source for projecting an illumination pattern through the display onto an object,
an image sensor for acquiring an image of the illuminated object through the display, and
the system according to claim 1.

11. A method for identifying a display device, the method comprising:
providing an image of an object, wherein the image has been acquired by projecting an illumination pattern through a display of the display device onto the object and imaging the illuminated object through the display,
extracting a reflection pattern corresponding to the illumination pattern from the image, and
determining an identity of the display device based on the reflection pattern.

12. A method for assessing an eligibility of a subject with respect a display device, the method comprising:
identifying the subject,
identifying the display device according to claim 11, and
assessing an eligibility of the subject with respect to the display device based on a predetermined assignment of eligibilities to pairs of a) subject identities and b) display device identities.

13. A computer program for identifying a display device, the program comprising program code means for causing a system to execute the method according to claim 11 when the program is run on a computer controlling the respective system.

14. A computer program for identifying a display device, the program comprising program code means for causing a system to execute the method according to claim 12, when the program is run on a computer controlling the respective system.

15. A computer program for identifying a display device, the program comprising program code means for causing the system according to claim 1 to execute a method, when the program is run on a computer controlling the respective system.
